(19) United States
(12) Patent Application Publication
(10) Pub. No.: US 2024/0112455 A1
(43) Pub. Date: Apr. 4, 2024

(54) METHODS AND SYSTEMS FOR MACHINE LEARNING MODEL TRAINING WITH HUMAN-ASSISTED REFINEMENT

(71) Applicant: Robert Bosch GmbH, Stuttgart (DE)

(72) Inventors: Wenbin He, Sunnyvale, CA (US); Md Naimul Hoque, Fairfax, VA (US); Liang Gou, San Jose, CA (US); Liu Ren, Saratoga, CA (US)

(21) Appl. No.: 17/953,225

(22) Filed: Sep. 26, 2022

(51) Int. Cl. G06V 10/778; G06N 20/00; G06V 10/74

(52) U.S. Cl. CPC G06V 10/7788; G06N 20/00; G06V 10/761

(57) ABSTRACT

A method for training a machine learning model. The method comprises receiving a training dataset that includes a plurality of images. The method also includes identifying, by a machine learning model, at least one portion of at least one image of the plurality of images in the training dataset associated with a first object type. The method further includes identifying other images having at least one portion that includes the first object type. The method also includes grouping the identified other images into a first image group. The method also includes generating for display a first user interface, that at least includes a rank matrix, wherein a first row of the rank matrix represents the images of the first image object. The user may provide feedback for the visualization using the first interface. The method may also include training the machine learning model based on the user feedback.

### TECHNICAL FIELD

The present disclosure relates to refining machine learning models based on minimal human input.

### BACKGROUND

Training accurate machine learning models require large amounts of annotated data. The more training data that is available for training, the more effective the training becomes. For larger models utilizing deep learning, even more, labeled data is required to successfully train the model. Unfortunately, the obvious solution of simply creating more annotated data as training datasets is not scalable. Human review of data and human annotation of that data is required to create additional training data.

In the case of training a machine learning model to identify features in an image, large sets of annotated image training data are required. The creation of annotated image training data requires a human to inspect an image and label the features of the image. The creation of annotated image training data is highly resource-intensive and costly. A human element is required for training of machine learning models because humans learn and reason from perceptual groups and structures. Humans may unravel complex correspondence between concepts, generalize knowledge, and understand unseen concepts. Similar reasoning power for a machine vision model may help it mimic human learning and generalize to multiple downstream applications. Additionally, object types are human-understandable and provide a means to quantify the interpretability of a model.

### SUMMARY

The systems and methods described herein provide for refining machine learning models based on minimal human input.

An aspect of the disclosed embodiments includes a method for training a machine learning model. The method includes receiving a training dataset that includes a plurality of images, and identifying, by a machine learning model, a first subset of images of the plurality of images. The first subset of images includes images associated with a first object type. The method also includes grouping the first subset of images into a first image group associated with the first object type, generating, for display, a first user interface that includes a rank matrix including a first aspect that represents images of the first image group, and receiving, at the first user interface, input indicating user feedback associated with the rank matrix; generating an object type identification rule based on the input. The method also includes training the machine learning model based on the object type identification rule.

Another aspect of the disclosed embodiments includes a system for identifying at least one object type in at least one image using a machine learning model. The system includes a processor and a memory. The memory includes instructions that, when executed by the processor, cause the processor to: receive a training dataset that includes a plurality of images; identify, by a machine learning model, a first subset of images of the plurality of images, wherein the first subset of images includes images associated with a first object type; group the first subset of images into a first image group associated with the first object type; generate a first user interface that includes a rank matrix including a first aspect that represents images of the first image group; receive, at the first user interface, input indicating user feedback associated with the rank matrix; generate an object type identification rule based on the input; train the machine learning model based on the object type identification rule; and identify, using the machine learning model, at least one aspect of at least one image that corresponds to at least one of the first object type and another object type or a plurality of object types, wherein the at least one image is provided to the machine learning model as an input.

Another aspect of the disclosed embodiments includes an apparatus for training a machine learning model. The apparatus includes a processor and a memory. The memory includes instructions that, when executed by the processor, cause the processor to: receive a training dataset that includes a plurality of images; identify, by a machine learning model, a first subset of images of the plurality of images, wherein the first subset of images includes images associated with a first object type; group the first subset of images into a first image group associated with the first object type; determine a similarity factor based on the first image group and at least one other image group; generate a graphical representation of the first image group based on, at least, the size of the first image group and the similarity factor; generate a first user interface that includes a rank matrix the graphical representation of the first image group; receive, at the first user interface, input indicating user feedback associated with the rank matrix; generate an object type identification rule based on the input; and train the machine learning model based on the object type identification rule.

### BRIEF DESCRIPTION OF THE DRAWINGS

FIG. 1 generally illustrates a system for training a neural network, according to the principles of the present disclosure.

FIG. 2 generally illustrates a computer-implemented method for training and utilizing a neural network, according to the principles of the present disclosure.

FIG. 3 is a flow diagram generally illustrating a high-level overview of the computer-implemented method for human-assisted machine learning model training, according to the principles of the present disclosure.

FIG. 4A is a flow diagram generally illustrating a high-level overview of the computer-implemented method for human-assisted machine learning model training with a rank matrix interface, according to the principles of the present disclosure.

FIG. 4B is a flow diagram generally illustrating a high-level overview of the computer-implemented method for human-assisted machine learning model training with a rule creation interface, according to the principles of the present disclosure.

FIG. 5 depicts a schematic diagram of an interaction between a computer-controlled machine and a control system, according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punchcutter, a cutter, or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example, an Mill apparatus, x-ray imaging apparatus or ultrasonic apparatus.

FIG. 12 depicts two user interfaces of the present disclosure and how they interact, based on the principles of the present disclosure.

FIG. 13 depicts two user interfaces of the present disclosure and how they interact, based on the principles of the present disclosure.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Training accurate machine learning models require large amounts of annotated data. The more training data that is available for training, the more effective the training becomes. For larger models utilizing deep learning, even more, labeled data is required to successfully train the model. Unfortunately, the obvious solution of simply creating more annotated data as training datasets is not scalable. Human review of data and human annotation of that data is required to create additional training data.

In the case of training a machine learning model to identify features in an image, large sets of annotated image training data are required. The creation of annotated image training data requires a human to inspect an image and label the features of the image. The creation of annotated image training data is highly resource-intensive and costly. A human element is useful for training machine learning models because humans learn and reason from perceptual groups and structures. Humans may unravel complex correspondence between concepts, generalize knowledge, and understand unseen concepts. Similar reasoning power for a machine vision model may help it mimic human learning and generalize to multiple downstream applications. Additionally, or alternatively, object types are human-understandable and provide a means to quantify the interpretability of a model. There is a need for a low-cost, scalable solution for creating annotated data to use as training datasets. The creation of datasets is critical for the introduction of machine learning solutions where extensive machine learning training is not available.

Accordingly, systems and methods, such as the systems and methods described herein, configured to describe a human-in-the-loop framework to iteratively learn object types using a self-supervised mode, may be desirable. The systems and methods described herein may be configured to provide a visualization of concepts learned by a self-supervised model to help a user interpret and understand the concepts.

The systems and methods described herein may be configured to use minimal human inputs to fine-tune the concepts and improve quality. A user may create rules to split, merge concepts, and create bidirectional relations between concepts. The user interfaces of the systems and methods described herein may be configured to provide an intuitive visual representation to summarize concepts and easy interaction for weak supervision of the concepts.

The systems and methods described herein may be configured to perform object type extraction. Given a dataset of images, the systems and methods described herein may be configured to extract a set of object types (e.g. human head, human hands, car headlight, etc.) from a dataset. The extraction is conducted using a self-supervised model, such as an SimCLR, an SegSort, a vector-quantized variational autoencoder, or other suitable self-supervised model.

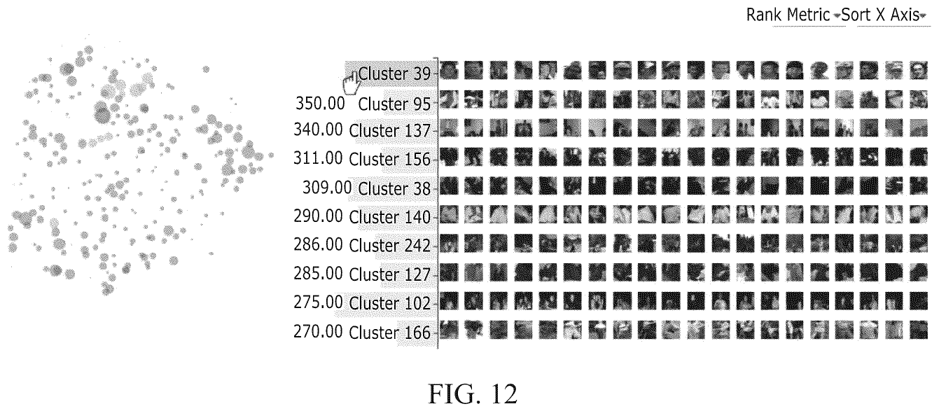

The systems and methods described herein may be configured to provide a rank matrix user interface. The systems and methods described herein may be configured to provide a view of object types to summarize the object types learned by a model (FIG. 12). Each row in the matrix represents an object type or cluster. For example, in FIG. 12, the second concept (e.g., illustrated as cluster 39) represents human heads. The representative images are most closely associated with the centroid of a concept. Each concept is accompanied by a bar, representing the number of images (e.g., size or other suitable characteristic) of a concept. A user may choose to order the matrix in ascending or descending order.

The systems and methods described herein may be configured to provide a scatter plot user interface. The scatter plot user interface may be provided with the rank matrix user interface. The scatter plot user interface may be configured to show the distance between the clusters or concepts (FIG. 12). The size of the circles represents the size (number of patches) of a concept. For example, a circle representing a large cluster of concepts will be proportionally larger than a circle representing a small cluster of concepts. A user may hover over any circle to see the corresponding concept in the rank matrix user interface and vice versa.

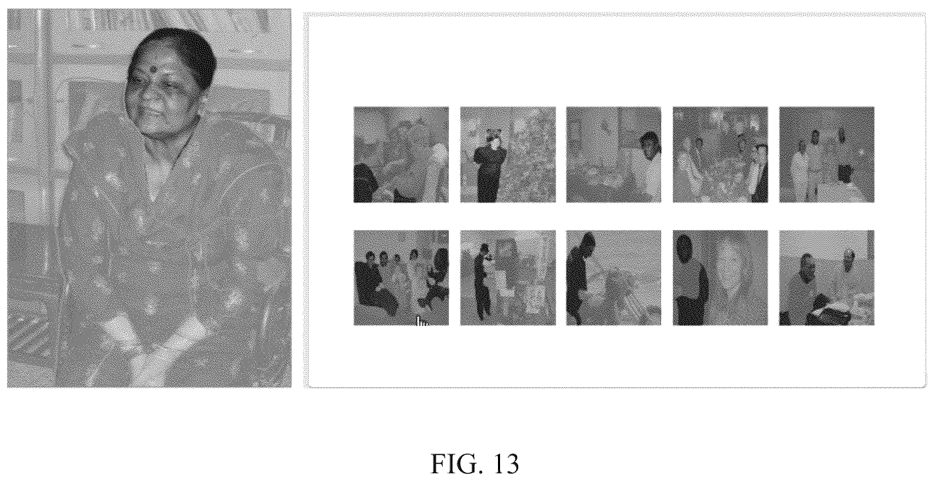

The systems and methods described herein may be configured to provide an image view user interface. The image view user interface shows an image with the mask representing all the segments as an overlay. A user may select a patch from the rank matrix user interface to see the corresponding image with the patch highlighted (FIG. 13). A user may hover over any segment in the image to see the corresponding concept in the rank matrix and scatter plot user interfaces.

The systems and methods described herein may be configured to provide a rule view user interface. The rule view user interface allows a user to create relations or rules between concepts. Such a rule indicates that the two concepts possess visual similarity or relation between them as perceived by an expert user. Once a rule is created, the rule view user interface displays representative images having both concepts (FIG. 13).

The systems and methods described herein may be configured to provide a weak supervision user interface. The systems and methods described herein may be configured to use weak supervision to fine-tune the concepts. The systems and methods described herein may be configured to receive weak supervision from a human expert. More specially, the systems and methods described herein may be configured to facilitate three types of weak supervision: split, merge, and relation. While split and merge are applied to a single concept, relations are created between two concepts. These relations may be created by following the two processes described below.

The systems and methods described herein may be configured to include a first method for creating rules for the self-supervised machine learning model. The first method allows a user to create a relation between two concepts directly from the rank matrix user interface. A user may click on any concept in the rank matrix user interface. In response to a click, the selected concept is highlighted in the rank matrix user interface with a green color. The concept is also highlighted in the scatter plot (FIG. 12). The rank matrix user interface and the scatter plot visualize the nearest neighbors of the selected concept in yellow based on the following metric:

$$Co - occurrence ( A , B ) = {{\sum }_{k}}^{n}$$

$$1 if A and B in image [ k ] , 0 otherwise$$

Where A, and B are two concepts, and n is the total number of images. A user may then select a yellow bar, or circle to create a relation.

The systems and methods described herein may be configured to create rules for the self-supervised machine learning model. The rules being generated in response to the user selecting a patch to be visualized in the image view user interface. The user may investigate the segments in the image view user interface, and observe the relevant concepts in the rank matrix user interface, and scatter plot user interface. The observation allow the user to gain a good insight into the co-occurrence between concepts. Based on the observations, the user may create a rule, and visualize sample examples for that rule, in the rule view user interface to correct any observed issues.

The systems and methods described herein may be configured to utilize the first machine learning model to train a second machine learning model. After several iterations of the human assisted training, the first machine learning model may reach a level of refinement where it can be used to train other machine learning models.

The systems and methods described herein may be configured to receive a training dataset that includes a plurality of images by at least one image capturing device. The systems and methods described herein may be configured to identify, by a machine learning model, at least one portion of at least one image of the plurality of images in the training dataset associated with a first object type. The systems and methods described herein may be configured to identify other images of the plurality of images in the training dataset having at least one portion that includes the first object type. The systems and methods described herein may be configured to group the identified other images of the plurality of images in the training dataset into a first image group. The systems and methods described herein may be configured to generate for display a first user interface that at least includes a rank matrix wherein a first row of the rank matrix represents the images of the first image object. The systems and methods described herein may be configured to receive, at the first interface, input indicating user feedback associated with the rank matrix. The systems and methods described herein may be configured to generate an object type identification rule based on the input. The systems and methods described herein may be configured to train the machine learning model based on the object type identification rule.

The systems and methods described herein may be configured so the first user interface is displayed with a second user interface, and the second user interface includes a visualization of the image groups. The systems and methods described herein may be configured to display each image group as a bubble, where a bubble size for each bubble is determined based on a number of image portions in the image group and a distance between each bubble is determined based on a level of similarity between each bubble.

The systems and methods described herein may be configured to, in response to receiving a user input select one of the rows of the matrix in the first user interface, highlight the respective bubble and highlight the bubbles representing image groups related to the image group selected by the user.

The systems and methods described herein may be configured so a bubble is displayed in a first color, a bubble selected by the user is displayed in a second color, and a bubble related to the bubble selected by the user is displayed in a third color.

The systems and methods described herein may be configured to receive a selection of a row of the matrix in the first user interface. The systems and methods described herein may be configured to display a third user interface which includes a representative image from the image group associated with the row of the matrix selected by the user is overlaid with a mask, where the mask divides the representative image into patches correlating with an object type, and the patch related to the object type associated with the row selected by the user is highlighted.

The systems and methods described herein may be configured so a rule is one of a group consisting of: an image group is incorrect and must be split into two or more image groups, two or more image groups are related to the same image concept and must be joined, and two or more image groups must be more closely associated.

The systems and methods described herein may be configured to, in response to at least one portion of at least one image of the plurality of images in the training dataset associated with a first object type and at least one other portion of the image is associated with a second object type, associating the image with the visual data grouping associated with the first object type and grouping the image with the visual data grouping associated with the second object type.

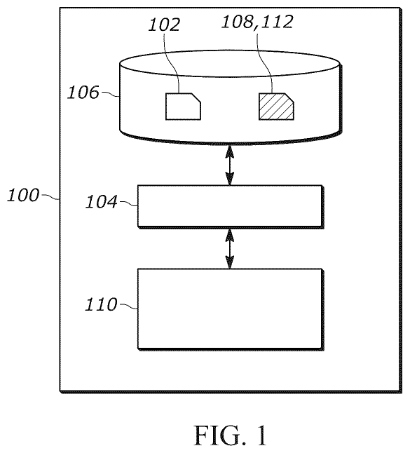

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

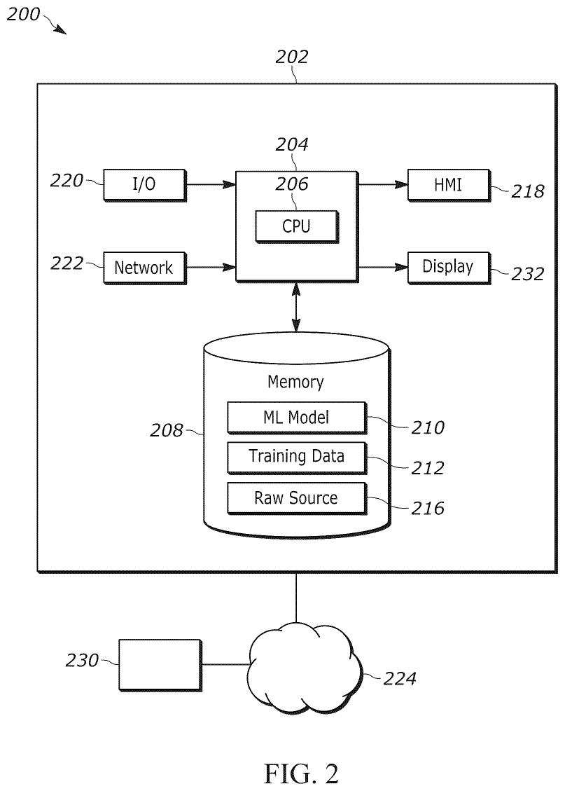

FIG. 2 depicts a data annotation system 200 to implement a system for annotating data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, and raw or partially processed sensor data (e.g., radar map of objects). In some embodiments, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 may compare output results (e.g., annotations) with those included in the training dataset 212. Since the training dataset 212 includes the expected results, the machine-learning algorithm 210 may determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., pedestrian). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In the example, the machine-learning algorithm 210 may process raw source data 216 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

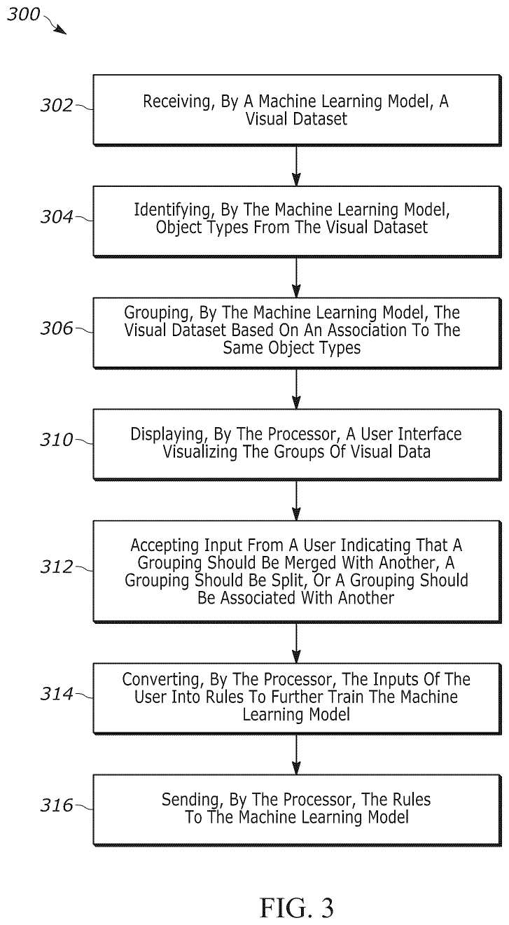

FIG. 3 is a flow chart generally illustrating the process of accepting human input in order to refine a machine learning model. At 302, the process 300 receives a visual data set. For example, the processor 204 may receive the visual data set. The visual dataset may be training data images where different objects in the image may be labeled. The visual dataset having been obtained from an input device. Examples of input devices may further include human interface inputs such as keyboards, mice, touchscreens, voice input devices, and other similar devices. The input devices may be associated with a device that is communicatively coupled to the computing system 202.

At 304, the process 300 identifies object types from the visual dataset using the machine learning model. For example, the processor 204 may identify the object types from the visual dataset using the machine learning model 210. The object types in the images may be a portion of a person (e.g., face, hands, mouth), an object (e.g., tree, building, car), an animal (sheep, bird, horse, dog), or other such objects.

At 306, the process 300 utilizes the machine learning model to group the images in the visual dataset into groups based on the object types identified by the machine learning model. For example, the processor 204 may group the images of the visual dataset into groups using the machine learning model 210. An image having multiple object types identified therein may be group into multiple groups of visual data.

At 310, the process 300 presents the user with a user interface which visualizes the groups of visual data. The user may observe the groups of visual data based on the identification of the machine learning model. For example, the processor 204 generate the user interface. The user may use the visualization to determine if the images are grouped correctly based on the contents of the images. At 312, the process 300 accepts input from the user indicating that a grouping is incorrect. The user's input may indicate that a group should be split into different groups, two groups should be merged, or the association between different groups should be altered. The association between two different groups may be incorrect and require a closer association, when the object types the group is based off of is similar.

At 312, the process 300 converts the input accepted from the user into a rule to further train the machine learning model. For example, the processor 204 may accept input from the user via human-machine interface device 218. At 314, the process 300 sends the rule to the machine learning model. The process 300 is intended to be iterative, at the end of each iteration the rules created by the user are used to further refine the training of the machine learning model.

It should be understood that the systems and methods described herein may be for various applications, such as those described herein with respect to FIGS. 6-11.

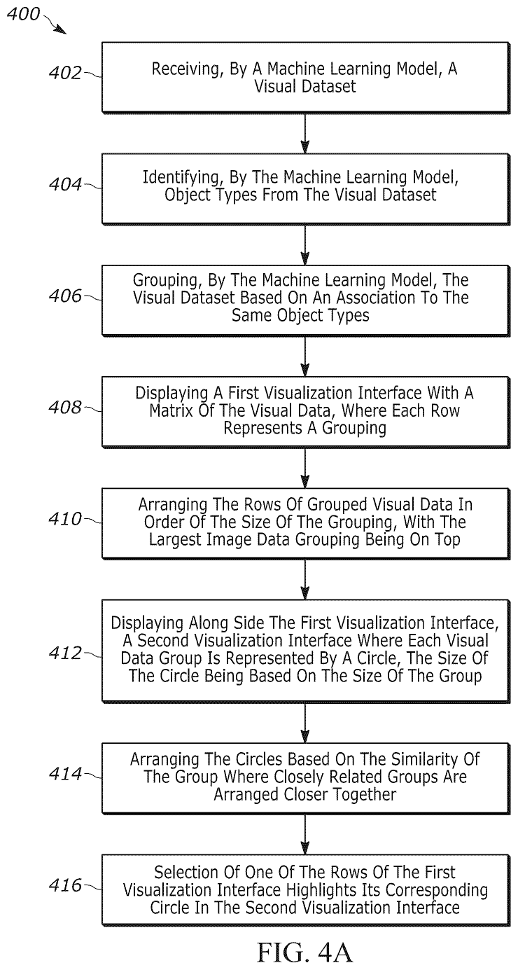

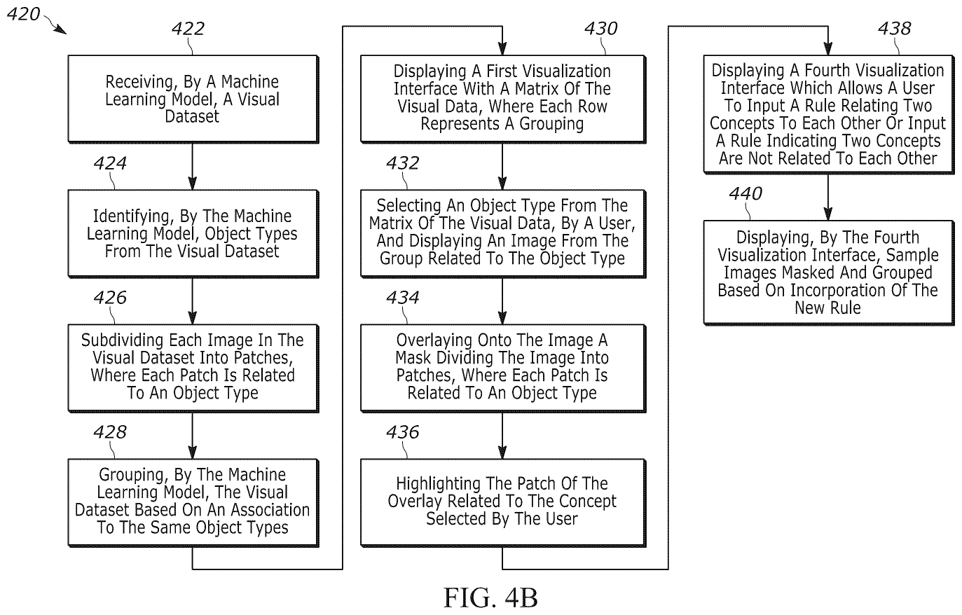

FIG. 4A is a flow chart generally illustrating the process of accepting human input in order to refine a machine learning model. At 402, the process 400 receives a visual data set. The visual dataset may be training data images where different objects in the image may be labeled. For example, the processor 204 may receive the visual dataset. At 404, the process 400 identifies object types from the visual dataset using the machine learning model. The object types in the images may be a portion of a person (e.g., face, hands, mouth), an object (e.g., tree, building, car), an animal (sheep, bird, horse, dog), or other such objects.

At 406, the process 400 utilizes the machine learning model to group the images in the visual dataset into groups based on the object types identified by the machine learning model. For example, the processor 204 may group the visual dataset using the machine learning model 210. An image having multiple object types identified therein may be group into multiple groups of visual data.

At 408, the process 400 presents the user with a user interface which visualizes the groups of visual data. For example, the processor 204 may generate the user interface which visualizes the groups of visual data. At 410, the process 400 arranges the user interface as a rank matrix where each group of visual data is arranged as a row of representative images. This interface may accept input from a user indicating the visual data is improperly grouped. Input may be received in the form of a drag and drop, where dragging one group and dropping them on another indicates the groups should be merged. Also, input may be received in the form of selecting a subset of visual data from one group and moving it into its own group.

At 412, the process 400 enhances the user interface with a scatter plot visualization of the visual data groupings. For example, the processor 204 may generate a user interface with the scatter plot visualization. The scatter plot represents each visual data grouping as a circle on the scatter plot where each circle is sized based on the number of images in the visual data grouping.

At 414, the process 400 arranges the position of the points on the scatter plot based on the level of similarity between the different visual data groupings. For example, the processor 204 may arrange the position of the points. The more closely associated the groupings are, the closer in position are the respective circles on the scatter plot. The user may interact with scatter plot to indicate the relationships between visual data groupings are incorrect. A user may drag a circle that is should not be as closely related to another circle to create a rule for refining the machine learning model.

At 416, the process 400 alters the display based on a selection from the user. When the user selects a visual data grouping on the rank matrix, the respective circle on the scatter plot will be highlighted. For example, the processor 204 may alter the display based on the selection from the user. The process 400 will further highlight related visual data groupings on the scatter plot with a different color or other appropriate means of differentiating the user interface elements. Further, selecting a row of the rank matrix will highlight its respective circle on the scatter plot and in differentiating manner also highlight the circles of related visual data groupings.

FIG. 4B is a flow chart generally illustrating the process of accepting human input in order to refine a machine learning model. At 422, the process 420 receives a visual data set. The visual dataset may be training data images where different objects in the image may be labeled. For example, the processor 204 may receive the visual data set. At 424, the process 420 identifies object types from the visual dataset using the machine learning model. The object types in the images may be a portion of a person (e.g., face, hands, mouth), an object (e.g., tree, building, car), an animal (sheep, bird, horse, dog), or other such objects.

At 426, the process 420 subdivides each image of the visual dataset into patches, where each patch is related to an object type. For example, in a visual image of the visual dataset where the subject of the image is a human, the process 420 will subdivide the image into segments having different concepts, such as the segment of the image having the human face. Other portions of the image may also be labeled. At 428, the process 420 groups the visual dataset based on an association to the same object types. The visual data groupings are created based on a shared object type in one of the image portions of the image. Images having multiple image portions related to a visual data grouping is associated with both visual data groupings.

At 430, the process 420 presents the user with a user interface which visualizes the groups of visual data. The process 420 further arranges the user interface as a rank matrix where each group of visual data is arranged as a row of representative images. This interface may accept input from a user indicating the visual data is improperly grouped. Input may be received in the form of a drag and drop, where dragging one group and dropping them on another indicates the groups should be merged. Also, input may be received in the form of selecting a subset of visual data from one group and moving it into its own group.

At 432, the process 420 accepts input from a user indicating a selection of a visual data grouping based on an object type. For example, the processor 204 may accept input from the user. Selection of a visual concept may be accomplished by selecting a row of the rank matrix or a circle on the scatter plot. The process 420, in response to the selection, displays a representative image of the object type grouping.

At 434, the process 420 overlays the representative image of the object type grouping with a mask dividing the image into patches, where each patch is related to an object type. For example, the processor 204 may overlay the representative image of the object type grouping with the mask. At 436, the process 436 highlights the patch of the overlay related to the concept selected by the user. For example, when the visual data grouping selected by the user is a human face, than the mask divides the image data of the representative image into sections based on object types recognized in the image. The image portion of the face being highlighted based on the selection of the user.

At 438, the process 420 displays an additional visualization interface which a user to input a rule relating two concepts to each other or input a rule indicating two concepts are not related to each other. For example, the processor 204 may receive input from the user to input the rule. Representative images from one or more groups or displayed with masks overlaid upon them. At 440, the process 400 displays portions of the images related to the object types being highlighted, each object type portion being highlighted in a distinctive manner to differentiate between object type portions. The process 420 accepting inputs from the user indicating the how to correct incorrect visual data groupings.

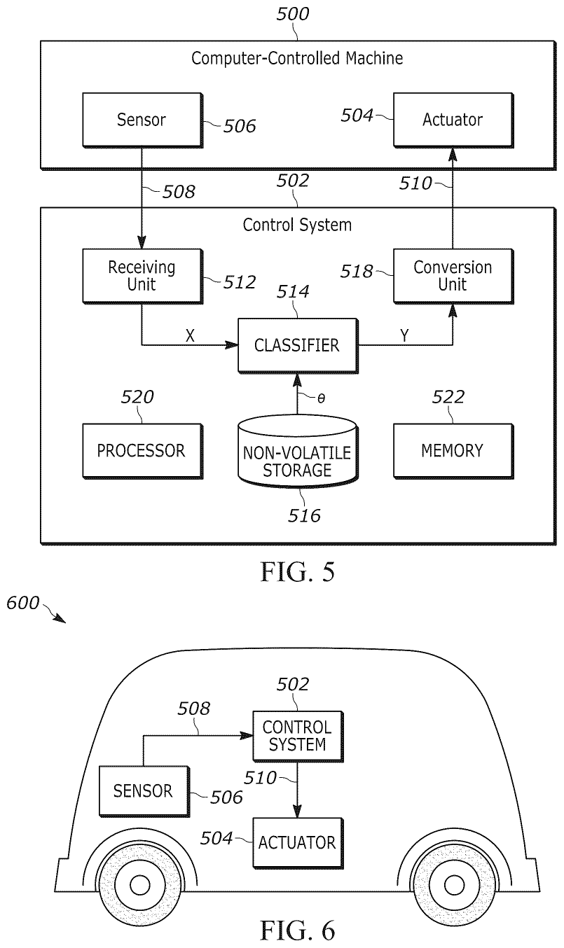

The systems and methods described herein may be configured to generate annotated training data in order to train a machine learning model. Such a machine learning model 208, having been trained with the annotated training data, may be used for any suitable application such as those described in FIGS. 5-11.

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that may be used to store the desired information and which may be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

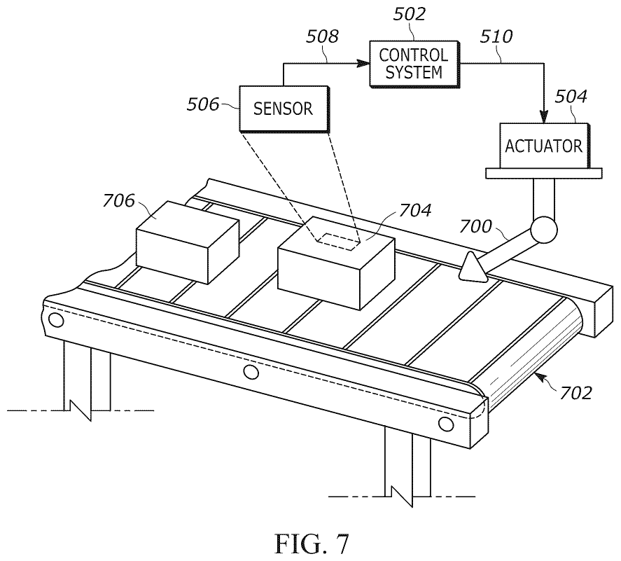

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

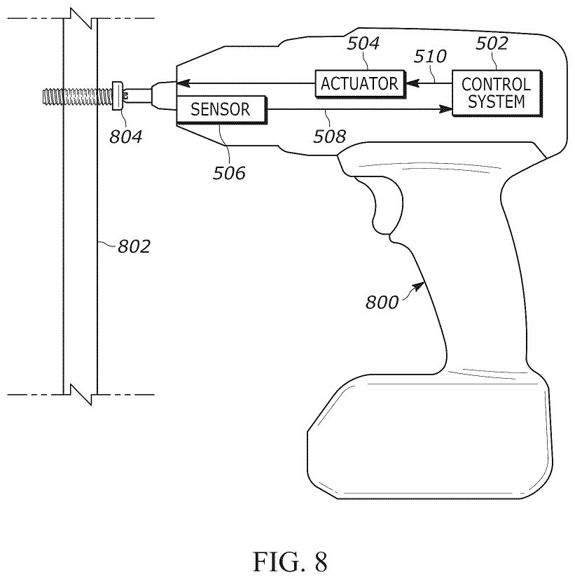

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

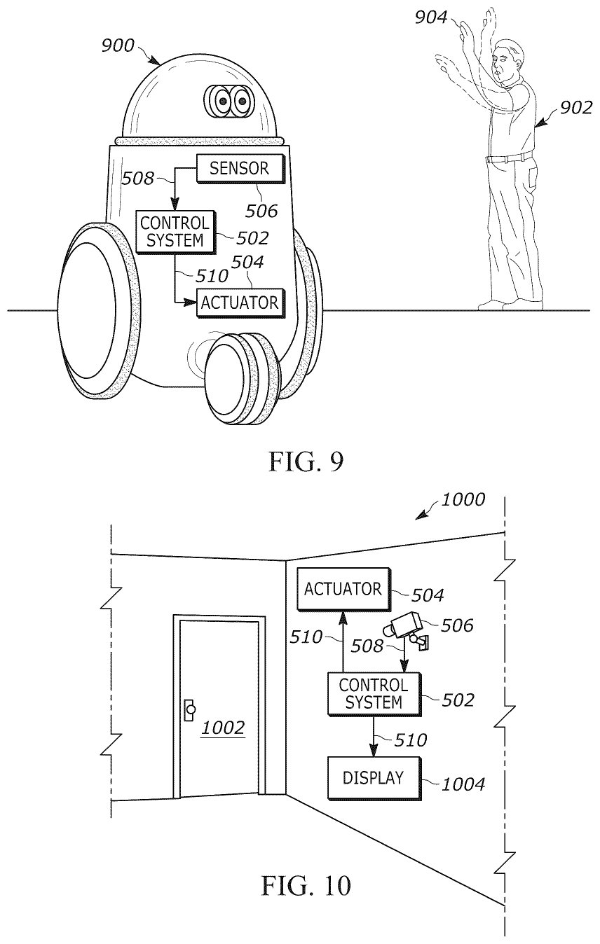

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

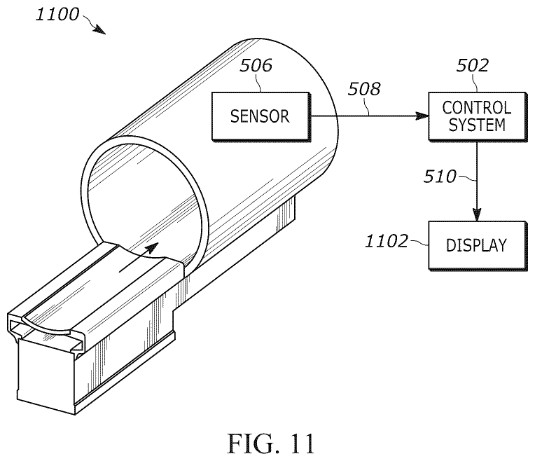

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

In some embodiments, a method for estimating input certainty for a neural network using generative modeling includes generating, using an input data, two or more input data and embedding vector combinations and providing, at the neural network, each of the two or more input data and embedding vector combinations. The method also includes receiving, from the neural network, an output value for each input data and embedding vector combination of the two or more input data and embedding vector combinations. The method also includes computing a variance value for the output values of each respective input data and embedding vector combinations and determining a certainty value for the input data based on the variance value.

In some embodiments, the output values correspond to a task performed by the neural network using respective input data and embedding vector combinations. In some embodiments, the task includes a classification task. In some embodiments, the task includes a regression task. In some embodiments, the input data includes deterministic input data. In some embodiments, the input data includes input data that is in domain for the neural network. In some embodiments, the input data includes input data that is out of domain for the neural network. In some embodiments, the embedding vector for each input data and embedding vector combination includes a random variable. In some embodiments, the embedding vector for each input data and embedding vector combination includes a low dimensional embedding vector.

In some embodiments, a system for estimating input certainty for a neural network using generative modeling includes a processor and a memory. The memory includes instructions that, when executed by the processor, cause the processor to: generate, using an input data, two or more input data and embedding vector combinations; provide, at the neural network, each of the two or more input data and embedding vector combinations; receive, from the neural network, an output value for each input data and embedding vector combination of the two or more input data and embedding vector combinations; compute a variance value for the output values of each respective input data and embedding vector combinations; and determine a certainty value for the input data based on the variance value.

In some embodiments, the output values correspond to a task performed by the neural network using respective input data and embedding vector combinations. In some embodiments, the task includes a classification task. In some embodiments, the task includes a regression task. In some embodiments, the input data includes deterministic input data. In some embodiments, the input data includes input data that is in domain for the neural network. In some embodiments, the input data includes input data that is out of domain for the neural network. In some embodiments, the embedding vector for each input data and embedding vector combination includes a random variable. In some embodiments, the embedding vector for each input data and embedding vector combination includes a low dimensional embedding vector.

In some embodiments, a method for estimating input certainty for a neural network includes receiving an input data from a sensor, wherein the input data is indicative of image, radar, sonar, or sound information. The method also includes generating, using the input data, two or more input data and embedding vector combinations, wherein the input data for each input data and embedding vector combinations includes the input data from the sensor and the embedding vector for each input data and embedding vector combinations includes a random variable. The method also includes providing, at the neural network, each of the two or more input data and embedding vector combinations and receiving, from the neural network, an output value for each input data and embedding vector combination of the two or more input data and embedding vector combinations. The method also includes computing a variance value for the output values of each respective input data and embedding vector combinations and determining a certainty value for the input data based on the variance value.

In some embodiments, the embedding vector for each input data and embedding vector combination includes a low dimensional embedding vector.

The processes, methods, or algorithms disclosed herein may be deliverable to/implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 12 is a representation of two visualizations of the visual data groups as described above. On the right there is a rank matrix with the top row being selected by the user. The row is highlighted to indicate its selection. Each row of the rank matrix represents a different visual data grouping based on an association to an object type. On the left is the associated scatter plot visualization of the same visual data groupings. The circle representing the selected visual concept grouping is highlighted in green, visual data groupings related to the selected visual data grouping are highlighted in green to indicate their association. A user interface element allows to alter how the rows of the rank matrix are organized. The rank matrix may sort rows of visual data groupings based on size, alphabetically, confidence score, or any other suitable metric.

The interface of FIG. 12 may include a rank matrix user interface. The interface of FIG. 12 may include a view of object types to summarize the object types learned by a model. Each row in this matrix represents an object type or cluster. For example, the second concept (cluster 39) represents human heads. The representative images are the closest ones to the centroid of a concept. Each concept is accompanied by a bar, representing the number of images (size) in a concept. A user may choose to order the matrix in ascending or descending order.

The interface of FIG. 12 may include a scatter plot user interface. A scatter plot user interface is provided with the rank matrix user interface to show the distance between the clusters or concepts. The size of the circles represents the size (number of patches) of a concept. A user may hover over any circle to see the corresponding concept in the rank matrix user interface and vice versa.

FIG. 13 may include an image view user interface. The image view user interface shows an image with the mask representing all the segments as an overlay. A user may select a patch from the rank matrix user interface to see the corresponding image with the patch highlighted. A user may hover over any segment in the image to see the corresponding concept in the rank matrix and scatter plot user interfaces.

The interface of FIG. 12 may also include a rule view user interface. The rule view user interface allows a user to create relations or rules between concepts. Such a rule indicates that the two concepts possess visual similarity or relation between them as perceived by an expert user. Once a rule is created, the rule view user interface displays representative images having both concepts.

In some embodiments, a method for training a machine model includes receiving a training dataset that includes a plurality of images. The method also includes identifying, by a machine learning model, at least one portion of at least one image of the plurality of images in the training dataset associated with a first object type. The method also includes identifying other images of the plurality of images in the training dataset having at least one portion that includes the first object type. The method also includes group the identified other images of the plurality of images in the training dataset into a first image group. The method also includes generating for display a first user interface that at least includes a rank matrix, wherein a first row of the rank matrix represents the images of the first image object. The method also includes receiving, at the first interface, input indicating user feedback associated with the rank matrix. The method also includes generating an object type identification rule based on the input. The method also includes training the machine learning model based on the object type identification rule.

In some embodiments, the method may also include the first user interface being displayed with a second user interface, and the second user interface includes a visualization of the image groups. The method also includes display each image group as a bubble, where a bubble size for each bubble is determined based on a number of image portions in the image group and a distance between each bubble is determined based on a level of similarity between each bubble.

In some embodiments, the method also includes, in response to receiving a user input select one of the rows of the matrix in the first user interface, highlight the respective bubble and highlight the bubbles representing image groups related to the image group selected by the user.

In some embodiments, the method may also include a bubble being displayed in a first color, a bubble selected by the user is displayed in a second color, and a bubble related to the bubble selected by the user is displayed in a third color.

In some embodiments, the method also includes receiving a selection of a row of the matrix in the first user interface. The method also includes displaying a third user interface which includes a representative image from the image group associated with the row of the matrix selected by the user is overlaid with a mask, where the mask divides the representative image into patches correlating with an object type, and the patch related to the object type associated with the row selected by the user is highlighted.

In some embodiments, the method may also include a rule being one of a group consisting of: an image group is incorrect and must be split into two or more image groups, two or more image groups are related to the same image concept and must be joined, and two or more image groups must be more closely associated.

In some embodiments, the method also includes, in response to at least one portion of at least one image of the plurality of images in the training dataset associated with a first object type and at least one other portion of the image is associated with a second object type, associating the image with the visual data grouping associated with the first object type and grouping the image with the visual data grouping associated with the second object type.

In some embodiments, a method for training a machine learning model includes: receiving a training dataset that includes a plurality of images; identifying, by a machine learning model, a first subset of images of the plurality of images, wherein the first subset of images includes images associated with a first object type; grouping the first subset of images into a first image group associated with the first object type; generating, for display, a first user interface that includes a rank matrix including a first aspect that represents images of the first image group; receiving, at the first user interface, input indicating user feedback associated with the rank matrix; generating an object type identification rule based on the input; and training the machine learning model based on the object type identification rule.

In some embodiments, the method also includes displaying, at the first user interface, a second user interface that includes a visualization of the first image group. In some embodiments, the method also includes determining, based on a number of object types associated with the first image group, a size of the visualization of the first image group. In some embodiments, the method also includes determining a similarity factor based on the first image group and at least one other image group. In some embodiments, the method also includes generating a graphical representation of the first image group based on, at least, a size of the first image group and the similarity factor. In some embodiments, the method also includes receiving, via the first user interface, a selection of a region of the rank matrix. In some embodiments, the method also includes generating an output that includes a representative image from an image group associated with the selected region.

In some embodiments, a system for identifying at least one object type in at least one image using a machine learning model includes a processor and a memory. The memory includes instructions that, when executed by the processor, cause the processor to: receive a training dataset that includes a plurality of images; identify, by a machine learning model, a first subset of images of the plurality of images, wherein the first subset of images includes images associated with a first object type; group the first subset of images into a first image group associated with the first object type; generate a first user interface that includes a rank matrix including a first aspect that represents images of the first image group; receive, at the first user interface, input indicating user feedback associated with the rank matrix; generate an object type identification rule based on the input; train the machine learning model based on the object type identification rule; and identify, using the machine learning model, at least one aspect of at least one image that corresponds to at least one of the first object type and another object type or a plurality of object types, wherein the at least one image is provided to the machine learning model as an input.

In some embodiments, the instructions further cause the processor to display, at the first user interface, a second user interface that includes a visualization of the first image group. In some embodiments, the instructions further cause the processor to determine, based on a number of object types associated with the first image group, a size of the visualization of the first image group. In some embodiments, the instructions further cause the processor to determine a similarity factor based on the first image group and at least one other image group. In some embodiments, the instructions further cause the processor to generate a graphical representation of the first image group based on, at least, a size of the first image group and the similarity factor. In some embodiments, the instructions further cause the processor to receive, via the first user interface, a selection of a row of the rank matrix. In some embodiments, the instructions further cause the processor to generate an output that includes a representative image from an image group associated with the selected row.

In some embodiments, an apparatus for training a machine learning model includes a processor and a memory. The memory includes instructions that, when executed by the processor, cause the processor to: receive a training dataset that includes a plurality of images by at least one image capturing device; identify, by a machine learning model, a first subset of images of the plurality of images, wherein the first subset of images includes images associated with a first object type; group the first subset of images into a first image group associated with the first object type; determine a similarity factor based on the first image group and at least one other image group; generate a graphical representation of the first image group based on, at least, the size of the first image group and the similarity factor; generate a first user interface that includes a rank matrix the graphical representation of the first image group; receive, at the first user interface, input indicating user feedback associated with the rank matrix; generate an object type identification rule based on the input; and train the machine learning model based on the object type identification rule.

In some embodiments, the at least one or more image capturing device may be associated with at least one of a stand-alone device such as, at least one of, a manufacturing machine, a power tool, an automated personal assistant, a domestic appliance, surveillance system, and a medical imaging system

In some embodiments, the instructions further cause the processor to display, at the first user interface, a second user interface that includes a visualization of the first image group. In some embodiments, the instructions further cause the processor to determine, based on a number of object types associated with the first image group, a size of the visualization of the first image group. In some embodiments, the instructions further cause the processor to determine a similarity factor based on the first image group and at least one other image group. In some embodiments, the instructions further cause the processor to identify, using the machine learning model, at least one aspect of at least one image that corresponds to at least one of the first object type and another object type or a plurality of object types. In some embodiments, the at least one image is provided to the machine learning model as an input.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and may be desirable for particular applications.

What is claimed is:

1. A method for training a machine learning model, the method comprising:
receiving a training dataset that includes a plurality of images;
identifying, by a machine learning model, a first subset of images of the plurality of images, wherein the first subset of images includes images associated with a first object type;
grouping the first subset of images into a first image group associated with the first object type;
generating, for display, a first user interface that includes a rank matrix including a first aspect that represents images of the first image group;
receiving, at the first user interface, input indicating user feedback associated with the rank matrix;
generating an object type identification rule based on the input; and
training the machine learning model based on the object type identification rule.

2. The method of claim 1, further comprising displaying, at the first user interface, a second user interface that includes a visualization of the first image group.

3. The method of claim 2, further comprising determining, based on a number of object types associated with the first image group, a size of the visualization of the first image group.

4. The method of claim 1, further comprising determining a similarity factor based on the first image group and at least one other image group.

5. The method of claim 4, further comprising generating a graphical representation of the first image group based on, at least, a size of the first image group and the similarity factor.

6. The method of claim 1, further comprising receiving, via the first user interface, a selection of a region of the rank matrix.

7. The method of claim 6, further comprising generating an output that includes a representative image from an image group associated with the selected region.

8. A system for identifying at least one object type in at least one image using a machine learning model, the system comprising:
a processor; and
a memory including instructions that, when executed by the processor, cause the processor to:
receive a training dataset that includes a plurality of images;
identify, by a machine learning model, a first subset of images of the plurality of images, wherein the first subset of images includes images associated with a first object type;
group the first subset of images into a first image group associated with the first object type;
generate a first user interface that includes a rank matrix including a first aspect that represents images of the first image group;
receive, at the first user interface, input indicating user feedback associated with the rank matrix;
generate an object type identification rule based on the input;
train the machine learning model based on the object type identification rule; and
identify, using the machine learning model, at least one aspect of at least one image that corresponds to at least one of the first object type and another object type or a plurality of object types, wherein the at least one image is provided to the machine learning model as an input.

9. The system of claim 8, wherein the instructions further cause the processor to display, at the first user interface, a second user interface that includes a visualization of the first image group.

10. The system of claim 9, wherein the instructions further cause the processor to determine, based on a number of object types associated with the first image group, a size of the visualization of the first image group.

11. The system of claim 8, wherein the instructions further cause the processor to determine a similarity factor based on the first image group and at least one other image group.

12. The system of claim 11, wherein the instructions further cause the processor to generate a graphical representation of the first image group based on, at least, a size of the first image group and the similarity factor.

13. The system of claim 8, wherein the instructions further cause the processor to receive, via the first user interface, a selection of a row of the rank matrix.

14. The system of claim 13, wherein the instructions further cause the processor to generate an output that includes a representative image from an image group associated with the selected row.

15. An apparatus for training a machine learning model, the apparatus comprising:
a processor; and
a memory including instructions that, when executed by the processor, cause the processor to:
receive a training dataset that includes a plurality of images captured by at least one image capturing device;
identify, by a machine learning model, a first subset of images of the plurality of images, wherein the first subset of images includes images associated with a first object type;
group the first subset of images into a first image group associated with the first object type;
determine a similarity factor based on the first image group and at least one other image group;
generate a graphical representation of the first image group based on, at least, the size of the first image group and the similarity factor;
generate a first user interface that includes a rank matrix the graphical representation of the first image group;
receive, at the first user interface, input indicating user feedback associated with the rank matrix;
generate an object type identification rule based on the input; and
train the machine learning model based on the object type identification rule.

16. The apparatus of claim 15, wherein the instructions further cause the processor to display, at the first user interface, a second user interface that includes a visualization of the first image group.

17. The apparatus of claim 16, wherein the instructions further cause the processor to determine, based on a number of object types associated with the first image group, a size of the visualization of the first image group.

18. The apparatus of claim 15, wherein the instructions further cause the processor to determine a similarity factor based on the first image group and at least one other image group.

19. The apparatus of claim 18, wherein the instructions further cause the processor to identify, using the machine learning model, at least one aspect of at least one image that corresponds to at least one of the first object type and another object type or a plurality of object types.

20. The apparatus of claim 15, wherein the at least one or more image capturing device may be associated with at least one of a manufacturing machine, a power tool, an automated personal assistant, a domestic appliance, surveillance system, and a medical imaging system.
